(19) United States
(12) Patent Application Publication
(10) Pub. No.: US 2026/0085999 A1
(43) Pub. Date: Mar. 26, 2026

(54) SUCTION AND DISPENSING APPARATUS

(71) Applicant: SHIMADZU CORPORATION, Kyoto (JP)

(72) Inventors: Motomu HINOOKA, Kyoto-shi (JP); Atsushi SAKAMOTO, Kyoto-shi (JP); Hironobu YAMADA, Kyoto-shi (JP)

(73) Assignee: SHIMADZU CORPORATION, Kyoto (JP)

(21) Appl. No.: 19/312,199

(22) Filed: Aug. 27, 2025

(30) Foreign Application Priority Data
Sep. 20, 2024 (JP) 2024-164204

(51) Int. Cl. G01N 1/14

(52) U.S. Cl. CPC G01N 1/14

(57) ABSTRACT

A suction and dispensing apparatus comprises a pump 105, a tip attachment part 103 to which a tip 120 is detachably attached, flow paths 131, 140 provided between the tip attachment part and the pump, and an on-off valve 104 and a passage 132 provided in the middle of the flow paths for switching between a state where an inside of the flow path is open to atmosphere and a state where it is not open to atmosphere.

### TECHNICAL FIELD

The present invention relates to a fluid suction and dispensing apparatus.

### BACKGROUND ART

In a pretreatment apparatus that performs predetermined pretreatment on a sample before analysis, a suction and dispensing apparatus is used to suck a sample or a reagent from a container and dispense it into another container (for example, see Patent Literature 1). Typically, a suction and dispensing apparatus is provided with a dispensing nozzle movable up and down, back and forth, and left and right, and a disposable tip is attached to the end of the dispensing nozzle. When performing dispensing with such a suction and dispensing apparatus, the dispensing nozzle is moved by a drive mechanism such as a motor to insert the tip (lower end) of the tip into a container holding a target reagent or the like, and a predetermined amount of liquid in the container is sucked into the tip by the action of a pump connected to the other end of the dispensing nozzle. Thereafter, the dispensing nozzle is moved to position the tip end over another container, and a predetermined amount of the liquid in the tip is dispensed into the other container by the action of the pump.

By the way, conventionally, a spoon has been generally used when portioning a cream-like fluid (high-viscosity fluid), but there is a demand to perform dispensing of such a high-viscosity fluid by a suction and dispensing apparatus as described above in order to realize automation.

### PRIOR ART DOCUMENTS

### Patent Literature

[Patent Literature 1] Japanese Unexamined Patent Application Publication No. 2012-117826

### SUMMARY OF THE INVENTION

### Problem to be Solved by the Invention

Suction and dispensing apparatuses include air displacement types, in which air is interposed between a pressurizing part of a pump (for example, a piston in a piston pump) and the liquid in a tip, and direct displacement types, in which air is not interposed. The aforementioned pretreatment apparatuses and the like are often provided with a versatile air displacement type suction and dispensing apparatus.

However, when a high-viscosity fluid as described above is sucked by an air displacement type suction and dispensing apparatus, air between the pressurizing part of the pump and the high-viscosity fluid in the tip continues to be sucked for a while even after the suction operation by the pump is stopped. Therefore, when the tip is lifted from the fluid, air may be sucked from the tip end, forming an air passage in the high-viscosity fluid within the tip, making it impossible to dispense the fluid. In addition, when dispensing a high-viscosity fluid with the same suction and dispensing apparatus, the dispensing of the high-viscosity fluid might not stop immediately even if the dispensing operation by the pump is stopped.

The present invention has been made in view of the above points, and an object thereof is to enable an air displacement type suction and dispensing apparatus to appropriately suck or dispense a high-viscosity fluid as described above.

### Means for Solving The Problem

A suction and dispensing apparatus according to the present invention made to solve the above problem comprises:
a pump;
a tip attachment part to which a tip is detachably attached;
a flow path provided between the tip attachment part and the pump; and
an atmosphere-releasing part provided in the middle of the flow path for switching between a state where the inside of the flow path is open to the atmosphere and a state where it is not open to the atmosphere.

A method for collecting a fluid according to the present invention made to solve the above problem is a method for collecting a fluid in a container using a suction and dispensing apparatus comprising a pump, a tip attachment part to which a tip is detachably attached, a flow path provided between the tip attachment part and the pump, and an atmosphere-releasing part provided in the middle of the flow path for switching between a state where the inside of the flow path is open to the atmosphere and a state where it is not open to the atmosphere, the method comprising:
a suction step of operating the pump with the tip of the tip placed in the fluid in the container to suck the fluid into the tip;
an atmosphere-releasing step of, after executing the suction step, stopping the pump and opening the flow path to the atmosphere by the atmosphere-releasing part; and
a tip-lifting step of, after executing the atmosphere-releasing step, lifting the tip from the fluid.

A method for discharging a fluid according to the present invention made to solve the above problem is a method for discharging a fluid in a tip in a suction and dispensing apparatus comprising a pump, a tip attachment part to which a tip is detachably attached, a flow path provided between the tip attachment part and the pump, and an atmosphere-releasing part provided in the middle of the flow path for switching between a state where the inside of the flow path is open to the atmosphere and a state where it is not open to the atmosphere, the method comprising:
a dispensing step of operating the pump to dispense the fluid in the tip; and
an atmosphere-releasing step of, after executing the dispensing step, stopping the pump and opening the flow path to the atmosphere by the atmosphere-releasing part.

### Effects of the Invention

According to the suction and dispensing apparatus of the present invention having the above configuration and the method for sucking a fluid using the same, the fluid is sucked into the tip with the tip of the tip placed in the fluid to be dispensed, and then, by stopping the pump and opening the flow path to the atmosphere before lifting the tip from the fluid, even if the fluid is a high-viscosity fluid, the formation of an air passage as described above in the fluid in the tip is prevented, and the fluid can be appropriately sucked.

Furthermore, according to the suction and dispensing apparatus of the present invention having the above configuration and the method for discharging a fluid using the same, by stopping the pump and opening the inside of the flow path to the atmosphere after dispensing a predetermined amount of the fluid held in the tip, the dispensing of the fluid from the tip can be stopped immediately, even if the fluid is a high-viscosity fluid.

### BRIEF DESCRIPTION OF THE DRAWINGS

FIG. 1 is a schematic configuration diagram of a suction and dispensing apparatus according to an embodiment of the present invention.

FIG. 2 is a flowchart showing the operation of the suction and dispensing apparatus.

### DESCRIPTION OF EMBODIMENTS

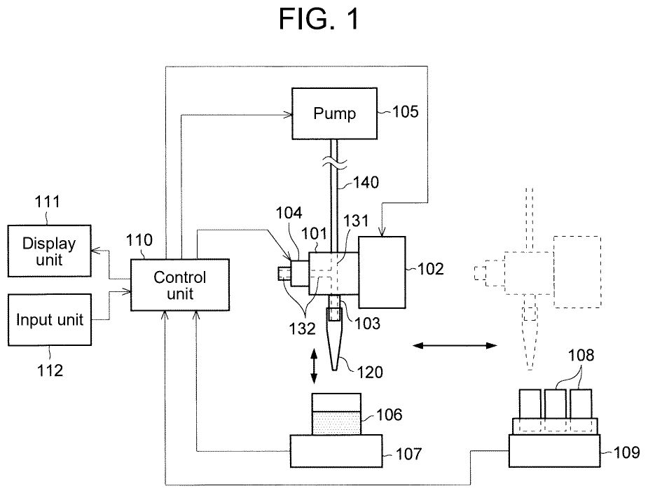

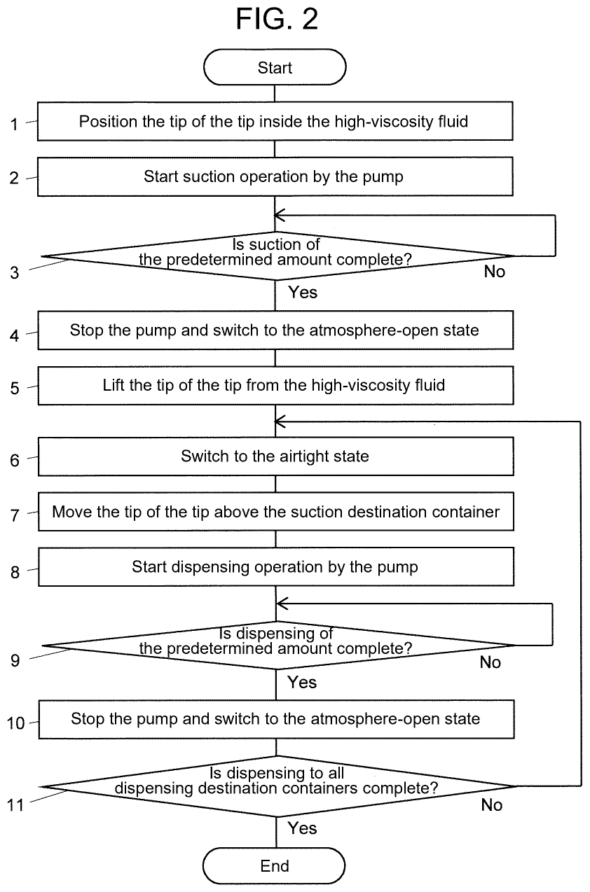

Hereinafter, an embodiment for carrying out the present invention will be described with reference to the drawings. FIG. 1 is a schematic configuration diagram of a suction and dispensing apparatus according to the present embodiment, and FIG. 2 is a flowchart showing the operation of the suction and dispensing apparatus.

The suction and dispensing apparatus according to the present embodiment comprises a suction and dispensing head 101, a suction and dispensing head moving mechanism 102 for moving the suction and dispensing head 101, a tip attachment part 103 provided on the suction and dispensing head 101, a pump 105, a first electronic balance 107 (corresponding to the suction source weight measuring unit in the present invention) on which a suction source container 106 containing a fluid to be dispensed is placed, a second electronic balance 109 (corresponding to the dispensing destination weight measuring unit in the present invention) on which a dispensing destination container 108 into which the fluid is dispensed is placed, a control unit 110, a display unit 111 including a liquid crystal display or the like, and an input unit 112 including operation buttons or a dial or the like.

The suction and dispensing head moving mechanism 102 includes a motor (not shown) and the like, and moves the suction and dispensing head 101 up and down, back and forth, and left and right based on instructions from the control unit 110. The tip attachment part 103 is a substantially cylindrical projection projecting downward from the suction and dispensing head 101. The lower end side of the tip attachment part 103 has a structure that can be fitted to the upper end part of a tubular tip 120 with a circular cross-section whose diameter decreases from the upper end to the lower end. The suction and dispensing head 101 may further be provided with a tip removal mechanism (not shown) for removing the tip 120 from the tip attachment part 103.

A first passage 131 extending vertically is formed inside the suction and dispensing head 101. The lower end of the first passage 131 communicates with the internal space of the tip attachment part 103, and the upper end of the first passage 131 is connected to a flexible tube 140 leading to the pump 105. Here, the first passage 131 and the tube 140 correspond to the flow path in the present invention.

As the pump 105, for example, a peristaltic pump, a diaphragm pump, or a syringe pump can be used, but it is not limited to these.

A second passage 132 extending laterally is further formed inside the suction and dispensing head 101, one end of the second passage 132 is connected to an intermediate part of the first passage 131, and the other end is open. An on-off valve 104 for opening and closing the second passage 132 is provided on the second passage 132. Here, the second passage 132 and the on-off valve 104 correspond to the atmosphere-releasing part in the present invention. The position of the second passage 132 and the on-off valve 104 is not limited to the above, and they may be provided at any position on the flow path from the tip attachment part 103 to the pump 105. The on-off valve 104 switches between a state where the second passage 132 is open (hereinafter referred to as the atmosphere-open state) and a state where the second passage 132 is closed (hereinafter referred to as the airtight state) based on an instruction from the control unit 110.

The control unit 110 is mainly configured with a microcomputer or the like including a CPU, RAM, ROM, etc., performs predetermined judgments based on output signals from the first electronic balance 107 and the second electronic balance 109, and generates control signals for performing dispensing operations (suction operation and dispensing operation) to be described later and sends them to the suction and dispensing head moving mechanism 102, the pump 105, and the on-off valve 104.

Hereinafter, the operation when sucking a high-viscosity fluid from the suction source container 106 into the tip 120 and dispensing a predetermined amount of the high-viscosity fluid in the tip 120 into each of a plurality of dispensing destination containers 108 by the suction and dispensing apparatus according to the present embodiment will be described with reference to the flowchart of FIG. 2.

The amount of the high-viscosity fluid to be sucked from the suction source container 106 into the tip 120 (hereinafter referred to as the set suction amount) and the amount of the high-viscosity fluid to be dispensed from the tip 120 to each dispensing destination container 108 (hereinafter referred to as the set dispensing amount), as well as the number and positions of the dispensing destination containers 108, are set in advance by the user using the input unit 112 and stored in the control unit 110. At this time, the setting is made such that (set suction amount)≥(set dispensing amount)×(number of dispensing destination containers). In addition, the user inputs the density of the high-viscosity fluid to be dispensed along with the values of the set suction amount and the set dispensing amount (both are volume values) and stores them in the control unit 110. Alternatively, a plurality of fluids and the density of each fluid may be stored in the control unit 110 in advance, and the user may be allowed to select the one to be dispensed from the plurality of fluids stored in the control unit 110.

Before starting the dispensing operation by the suction and dispensing apparatus according to the present embodiment, the suction source container 106 containing the high-viscosity fluid to be dispensed is placed on the first electronic balance 107, and the plurality of dispensing destination containers 108 are placed on the second electronic balance 109. Furthermore, the tip 120 is attached to the tip attachment part 103 in advance.

First, when the user performs a predetermined operation on the input unit 112 to instruct the start of dispensing, under the control of the control unit 110, the suction and dispensing head moving mechanism 102 moves the suction and dispensing head 101 above the suction source container 106, and further lowers the suction and dispensing head 101 to position the tip of the tip 120 inside the high-viscosity fluid (Step 1). At this time, the on-off valve 104 is in the aforementioned airtight state.

Subsequently, under the control of the control unit 110, the suction operation by the pump 105 is started (Step 2). As a result, the air in the flow path from the pump 105 through the tube 140, the first passage 131, and the internal space of the tip attachment part 103 to the tip 120 is sucked by the pump 105, creating a negative pressure in the flow path, and along with this, the high-viscosity fluid in the suction source container 106 is sucked into the tip 120.

The control unit 110 monitors the measured value by the first electronic balance 107 at this time and repeatedly determines at a predetermined time interval whether the suction of the set suction amount of the high-viscosity fluid has been completed (Step 3). This determination is made, for example, by converting the difference (weight) between the measured value of the first electronic balance 107 before the start of the suction operation and the current measured value into a volume using the density of the high-viscosity fluid stored in the control unit 110, and confirming whether the volume has reached the set suction amount.

Then, at the time when it is determined that the suction of the set suction amount of the high-viscosity fluid has been completed (i.e., when Yes in Step 3), the control unit 110 stops the suction operation by the pump 105 and switches the on-off valve 104 to the aforementioned atmosphere-open state (Step 4). As a result, the atmosphere flows into the first passage 131 via the second passage 132, and the negative pressure in the flow path is eliminated.

After that, the suction and dispensing head moving mechanism 102 lifts the tip 120 from the high-viscosity fluid by moving the suction and dispensing head 101 upward (Step 5).

Then, the on-off valve 104 is switched to the aforementioned airtight state (Step 6), and the suction and dispensing head 101 is moved to position the tip of the tip 120 above any of the plurality of dispensing destination containers 108 (Step 7). Note that Step 6 and Step 7 may be performed in the reverse order. Subsequently, under the control of the control unit 110, the dispensing operation by the pump 105 is started (Step 8). As a result, the inside of the aforementioned flow path is pressurized to a positive pressure, and along with this, the high-viscosity fluid in the tip 120 is dispensed into the dispensing destination container 108.

The control unit 110 monitors the measured value by the second electronic balance 109 at this time and repeatedly determines at a predetermined time interval whether the dispensing of the set dispensing amount of the high-viscosity fluid has been completed (Step 9). This determination is made, for example, by converting the difference (weight) between the measured value of the second electronic balance 109 before the start of the dispensing operation and the current measured value into a volume using the density of the high-viscosity fluid stored in the control unit 110, and confirming whether the volume has reached the set dispensing amount.

Then, at the time when it is determined that the dispensing of the set dispensing amount of the high-viscosity fluid has been completed (i.e., when Yes in Step 9), the control unit 110 stops the dispensing operation by the pump 105 and switches the on-off valve 104 to the aforementioned atmosphere-open state (Step 10). As a result, the air in the first passage 131 is discharged into the atmosphere via the second passage 132, and the positive pressure in the flow path is eliminated.

Thereafter, the control unit 110 determines whether the dispensing of the high-viscosity fluid to all the preset dispensing destination containers 108 has been completed (Step 11). If it is determined that it has not been completed, the process returns to Step 6, the on-off valve 104 is switched to the airtight state, and then the suction and dispensing head 101 is moved by the suction and dispensing head moving mechanism 102 to position the tip of the tip 120 above the next dispensing destination container 108 (Step 7), and the high-viscosity fluid is dispensed to the next dispensing destination container 108 in the same manner as in Steps 8 to 10 described above. Thereafter, Steps 6 to 11 are repeatedly executed until it is determined in Step 11 that the dispensing of the high-viscosity fluid to all the dispensing destination containers 108 has been completed (i.e., until Yes in Step 11), and the series of operations is terminated when Step 11 becomes Yes.

As described above, according to the suction and dispensing apparatus of the present embodiment, by switching the on-off valve 104 from the airtight state to the atmosphere-open state to eliminate the negative pressure inside the tip 120 before lifting the tip 120 from the high-viscosity fluid, it is possible to prevent air from being sucked from the tip of the tip 120 when the tip 120 is lifted. As a result, it becomes possible to avoid a situation where an air passage is formed in the high-viscosity fluid in the tip 120, making it impossible to dispense the fluid. Furthermore, by switching the on-off valve 104 from the airtight state to the atmosphere-open state to release the positive pressure inside the tip 120, it becomes possible to immediately stop the outflow of the high-viscosity fluid from the tip 120.

In addition, according to the suction and dispensing apparatus of the present embodiment, by stopping the suction operation by the pump 105 at the time when it is determined based on the measured value of the first electronic balance 107 that the suction amount of the high-viscosity fluid has reached the set suction amount, an accurate amount of the high-viscosity fluid can be sucked into the tip 120. Furthermore, according to the suction and dispensing apparatus of the present embodiment, by stopping the dispensing operation by the pump 105 at the time when it is determined based on the measured value of the second electronic balance 109 that the dispensing amount of the high-viscosity fluid has reached the set dispensing amount, an accurate amount of the high-viscosity fluid can be dispensed into each dispensing destination container 108.

Although the embodiment for carrying out the present invention has been described above with specific examples, the present invention is not limited to the above-described embodiment, and appropriate modifications are permissible within the spirit of the present invention. For example, the suction and dispensing apparatus according to the present invention may not be provided with the first electronic balance 107 and the second electronic balance 109 as described above, and the control unit 110 may determine whether the suction of the set suction amount of the high-viscosity fluid has been completed and whether the dispensing of the set dispensing amount of the high-viscosity fluid has been completed based on the drive amount of the pump 105. Alternatively, without making such a determination, the suction or dispensing operation by the pump 105 may be stopped and the on-off valve 104 may be switched from the airtight state to the atmosphere-open state at the time when the pump 105 has been driven by a preset drive amount.

In the above embodiment, the control of the pump 105 and the on-off valve 104, as well as the movement of the suction and dispensing head 101, are performed automatically, but these may be performed manually by the user. In that case, the suction and dispensing apparatus according to the present embodiment is to be held and used by the user, and the control of the pump 105 and the on-off valve 104 is to be performed by the user operating operation buttons or the like provided on the input unit 112.

In the above embodiment, the high-viscosity fluid sucked into the tip 120 is dispensed into a plurality of dispensing destination containers 108, but the high-viscosity fluid sucked into the tip 120 may be dispensed into a single dispensing destination container 108.

The atmosphere-releasing part in the present invention is not limited to one provided with the on-off valve 104 for opening and closing the second passage 132 as described above, and may be, for example, one provided with a three-way valve that switches between a state where the tip attachment part 103 is connected to the first passage 131 (corresponding to the airtight state described above) and a state where the tip attachment part 103 is connected to the second passage 132 (corresponding to the atmosphere-open state described above).

### Modes

It will be apparent to those skilled in the art that the exemplary embodiments described above are specific examples of the following aspects.

(Aspect 1) A suction and dispensing apparatus according to one aspect of the present invention comprises:
a pump;
a tip attachment part to which a tip is detachably attached;
a flow path provided between the tip attachment part and the pump; and
an atmosphere-releasing part provided in the middle of the flow path for switching between a state where the inside of the flow path is open to the atmosphere and a state where it is not open to the atmosphere.

(Aspect 2) The suction and dispensing apparatus according to Aspect 1, further comprising:
a control unit that controls the pump and the atmosphere-releasing part so as to stop the suction operation of the fluid and open the flow path to the atmosphere at the time when the suction of a predetermined amount of the fluid into the tip is completed.

(Aspect 3) The suction and dispensing apparatus according to Aspect 2, further comprising:
a suction source weight measuring unit that measures the weight of the fluid in a suction source container of the fluid,
wherein the control unit determines whether the suction of the predetermined amount of the fluid has been completed based on a measured value by the suction source weight measuring unit.

(Aspect 4) The suction and dispensing apparatus according to Aspect 1, further comprising:
a control unit that controls the pump and the atmosphere-releasing part so as to stop the dispensing operation of the fluid and open the flow path to the atmosphere at the time when the dispensing of a predetermined amount of the fluid from the tip is completed.

(Aspect 5) The suction and dispensing apparatus according to Aspect 4, further comprising:
a dispensing destination weight measuring unit that measures the weight of the fluid in a dispensing destination container of the fluid,
wherein the control unit determines whether the dispensing of the predetermined amount of the fluid has been completed based on a measured value by the dispensing destination weight measuring unit.

(Aspect 6) A method for collecting a fluid using a suction and dispensing apparatus comprising a pump, a tip attachment part to which a tip is detachably attached, a flow path provided between the tip attachment part and the pump, and an atmosphere-releasing part provided in the middle of the flow path for switching between a state where the inside of the flow path is open to the atmosphere and a state where it is not open to the atmosphere, the method comprising:
a suction step of operating the pump with the tip of the tip placed in the fluid in a container to suck the fluid into the tip;
an atmosphere-releasing step of, after executing the suction step, stopping the pump and opening the flow path to the atmosphere by the atmosphere-releasing part; and
a tip-lifting step of, after executing the atmosphere-releasing step, lifting the tip from the fluid.

(Aspect 7) A method for discharging a fluid in a tip in a suction and dispensing apparatus comprising a pump, a tip attachment part to which a tip is detachably attached, a flow path provided between the tip attachment part and the pump, and an atmosphere-releasing part provided in the middle of the flow path for switching between a state where the inside of the flow path is open to the atmosphere and a state where it is not open to the atmosphere, the method comprising:
a dispensing step of operating the pump to dispense the fluid in the tip; and
an atmosphere-releasing step of, after executing the dispensing step, stopping the pump and opening the flow path to the atmosphere by the atmosphere-releasing part.

### REFERENCE SIGNS LIST

101 . . . Suction and dispensing head
102 . . . Suction and dispensing head moving mechanism
103 . . . Tip attachment part
104 . . . On-off valve (Atmosphere-releasing part)
105 . . . Pump
106 . . . Suction source container
107 . . . First electronic balance
108 . . . Dispensing destination container
109 . . . Second electronic balance
110 . . . Control unit
111 . . . Display unit
112 . . . Input unit
120 . . . Tip
131 . . . First passage
132 . . . Second passage
140 . . . Tube

1. A suction and dispensing apparatus, comprising:
a pump;
a tip attachment part to which a tip is detachably attached;
a flow path provided between the tip attachment part and the pump; and
an atmosphere-releasing part provided in the middle of the flow path for switching between a state where an inside of the flow path is open to atmosphere and a state where the inside of the flow path is not open to atmosphere.

2. The suction and dispensing apparatus according to claim 1, further comprising:
a control unit that controls the pump and the atmosphere-releasing part to stop a suction operation of a fluid and open the flow path to the atmosphere when suction of a predetermined amount of the fluid into the tip is completed.

3. The suction and dispensing apparatus according to claim 2, further comprising:
a suction source weight measuring unit that measures a weight of the fluid in a suction source container of the fluid,
wherein the control unit determines whether the suction of the predetermined amount of the fluid has been completed based on a measured value by the suction source weight measuring unit.

4. The suction and dispensing apparatus according to claim 1, further comprising:
a control unit that controls the pump and the atmosphere-releasing part to stop a dispensing operation of a fluid and open the flow path to the atmosphere when dispensing of a predetermined amount of the fluid from the tip is completed.

5. The suction and dispensing apparatus according to claim 4, further comprising:
a dispensing destination weight measuring unit that measures a weight of the fluid in a dispensing destination container of the fluid, wherein the control unit determines whether the dispensing of the predetermined amount of the fluid has been completed based on a measured value by the dispensing destination weight measuring unit.

6. A method for collecting a fluid in a container using a suction and dispensing apparatus comprising a pump, a tip attachment part to which a tip is detachably attached, a flow path provided between the tip attachment part and the pump, and an atmosphere-releasing part provided in the middle of the flow path for switching between a state where an inside of the flow path is open to atmosphere and a state where the inside of the flow path is not open to atmosphere, the method comprising:
a suction step of operating the pump with a tip of the tip placed in the fluid in the container to suck the fluid into the tip;
an atmosphere-releasing step of, after executing the suction step, stopping the pump and opening the flow path to the atmosphere by the atmosphere-releasing part; and
a tip-lifting step of, after executing the atmosphere-releasing step, lifting the tip from the fluid.

7. A method for discharging a fluid in a tip in a suction and dispensing apparatus comprising a pump, a tip attachment part to which a tip is detachably attached, a flow path provided between the tip attachment part and the pump, and an atmosphere-releasing part provided in the middle of the flow path for switching between a state where an inside of the flow path is open to atmosphere and a state where the inside of the flow path is not open to atmosphere, the method comprising:
a dispensing step of operating the pump to dispense the fluid in the tip; and
an atmosphere-releasing step of, after executing the dispensing step, stopping the pump and opening the flow path to the atmosphere by the atmosphere-releasing part.
